(19) United States
(12) Patent Application Publication
(10) Pub. No.: US 2006/0174141 A1
(43) Pub. Date: Aug. 3, 2006

(54) Power saving circuit

(75) Inventor: Ching-Chung Chang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/049,149

(22) Filed: Feb. 2, 2005

(51) Int. Cl. G06F 1/26

(52) U.S. Cl. 713/300

(57) ABSTRACT

A power saving circuit is provided using an application specific integrated circuit (ASIC) and a power control units to control power provided to each interior part of the electronic device is disclosed to reduce the energy consumption of the electronic device, so that the electronic device can conform to the stricter energy standard.

### BACKGROUND OF THE INVENTION

1. Field of Invention

The invention relates to a power saving circuit, which controls power supplied to each interior part of a device according to the usage state of the electronic device in order to reduce energy consumption.

2. Related Art

With continuous development and improvement in electronic technologies, consumer electronics have more powerful and faster functions. Scanners also become more compact and lighter in weight. Of course, as there are more functions and the speed becomes faster, more powerful devices are needed in the electronics. As a result, the power consumption is larger than before. In accordance with the trends of protecting the environment and of saving energy, how to extend the functions of the scanners to their extreme while reducing energy consumption has become an important subject to be studied.

The interior of a conventional scanner includes: a power supply unit, a photo sensor, an analog front end (AFE) device, an application specific integrated circuit (ASIC), a stepping motor, a luminance loading, a warm-up device for the luminance loading, an automatic document feeder (ADF), and a control unit. In particular, the power supply unit provides necessary power to each interior part of the scanner. The photo sensor is generally a charge-coupled device (CCD) for receiving light reflected from the scanned document and converting the received optical signal into a data signal for output. The AFE device is used to rectify the received data signal from the photo sensor. The ASIC is used to control the scanning speed of the photo sensor. The luminance loading is generally a cold cathode fluorescent lamp (CCFL) for emitting light onto the document. The warm-up device enables the luminance loading to reach stable radiation. The ADF is used to feed the document during the scanning. Finally, the control unit is a user interface (UI) for setting the scanner.

In the operation of conventional scanners, the power supply unit provides power to each interior part of the scanner to start them once it is turned on. In particular, during the standby period, the luminance loading, i.e. the CCFL, of the scanner is still on to ensure the scanning quality. However, this method is not environmentally friendly and is likely to reduce the lamp lifetime. Therefore, to save power consumption, another method is to turn off the power for the CCFL while standby.

In the new 2006 energy standard set forth by the USA Environmental Protection Agency (EPA) requires that the standby power consumption of the scanner not be larger than 6 W and the shutdown power consumption not be larger than 1 W. Although there is already power saving device in the conventional scanners (i.e. turning off the lamp power when it is standby), the power consumption is still as high as 17 W or more. Therefore, they cannot meet the strict standard set forth by the USA EPA.

How to meet the stricter standard while at the same time making full use of the scanner is an important subject in scanner designing.

### SUMMARY OF THE INVENTION

Accordingly, the present invention is directed to a power saving circuit that substantially obviates one or more of the problems about power consumption waste due to limitations and disadvantages of the related art

The disclosed power saving circuit can control the power supply to each interior part of an electronic device according to its usage state, achieving the goal of saving energy.

When electronic devices become more versatile and powerful according to consumer's needs, the invention can solve the associated problem of large energy consumption.

To achieve the above objective, the invention provides a power saving circuit to save the energy consumption of an electronic device. It includes: ASIC and at least one power control unit. The ASIC are used to generate signals according to the state of the electronic device. The power control unit is connected to the ASIC to control the voltages supplied to loadings in the electronic device.

More than one power control unit can be used according to the number of loadings being controlled. That is, several power cutting devices, voltage-controlled oscillation devices, or a combination of the above two can be selected as the power control units in accordance to the practical needs of the electronic device.

Moreover, the power cutting devices control the energy consumption of the loadings by cutting or supplying the voltages that they need. The voltage-controlled oscillation devices control the power consumption by reducing or supplying voltages to the loadings. A trigger signal is used to start these devices, thereby achieving the goal of reducing the energy consumption of the device.

In addition, the ASIC are selected according to the needs of the power control unit. For a scanner, more than one power control unit may be used to control the power supplied to the interior parts. The number of the power control units is determined by the number of interior elements of the scanner. This enables the possibility of efficiently reducing energy consumption.

The power control unit controls the power supply according to the signal provided by the ASIC. That is, the power to a controlled loading is controlled by the signal provided by the ASIC. Therefore, the invention can achieve the effect of reducing energy consumption.

The power cutting device can cut off the power supplied to a controlled loading when it is not in use. It includes: a first signal source, a voltage source, first and second switching units, and a voltage output terminal. Moreover, the voltage-controlled oscillation device reduces the power supply to the controlled loading when it is not in use and is started by a trigger signal. The voltage-controlled oscillation device includes a second and a third signal sources, a voltage source, a third and a fourth switching units, and a voltage output terminal.

Since each element in the electronic device has its own action, we cannot turn off the power of all parts simply for saving the energy consumption because this may result in the fact that the electronic device is out of control or the user control interface disappears. If the electronic device is further connected to some other device, the connection may break because of this. In this case, one has to restart the electronic device in order to use it. This is very inconvenient and lowers the efficiency. Moreover, restarting requires larger power consumption, which may result in more energy loss and shortening its lifetime. Therefore, the invention selects an appropriate power control mode according to the actions of its interior elements, thereby achieving efficiency energy consumption.

As a simple example, if one uses a power cutting device as the first power control unit and a voltage-controlled oscillation device as the second power control unit in a scanner, the first power control unit controls the power of some interior parts inside the scanner. The power is turned off when the scanner is standby or shut down. These interior parts are the elements that are not in use when the scanner is standby. The second power control unit is also used to control the power of the other interior parts to reduce their power supply. When the power of the scanner is turned on/off, the power of these parts are immediately turned on/off. Such elements are specific elements inside the scanner.

Since many elements inside the scanner are not in use during the standby, their power supplies are immediately cut off after the scanner is idle for a certain period of time (the idle time set in the scanner before it enters the standby state) in order to save energy. Such elements include the CCD, the stepping motor, the AFN device, the ASIC, and the ADF in the scanner. Furthermore, cutting off the power of some interior elements in the scanner may result in losing the UI and the host in connection. Therefore, one has to restart it before the scanner can be used. This causes more power consumption and one has to wait until the scanning system becomes stable. This brings more inconvenience and lowers the efficiency. Therefore, to avoid unnecessary inconvenience and efficiency sacrifice, such elements are categorized as the specific elements, including the power supply unit and the control units. When the scanner stands by, the power for the specific elements are lowered to the extent of maintaining the necessary power for scanner connection and immediate use. Therefore, when the restart signal is received, the scanner can be used immediately. In other words, the invention achieves the objective of saving energy by reducing the power for necessary elements.

Some elements in the scanner have to wait for a few minutes after they are supplied with power. Such elements do not affect the connection and control of the scanner; they need some time before the scanner reaches an optimized state. Therefore, their power can be shut down when the scanner stands by. If the efficiency of an element may be affected, and if it is shut down during standby, then the invention simply reduces its power supply instead. That is, the invention allows the user to determine the power saving mode of these elements, such as the luminance loading of the scanner.

The disclosed power saving circuit can be applied in various electronic devices such as scanners and multiple function peripherals (MFP).

The disclosed power saving circuit uses a scanner as the electronic device to verify the energy-saving effect of the invention.

In the new 2006 energy standard set forth by the USA EPA requires that the standby power consumption of the scanner not be larger than 6 W and the shutdown (referring to the situation where the scanner power cord is plugged into the outlet but the machine is not on) power consumption not be larger than 1 W. Measuring a scanner not using the disclosed power saving circuit finds that its standby power consumption is 17.24 W and its shutdown power consumption is 2.5 W. One sees that the power consumption is much higher than the USA EPA standard. When measuring a scanner using the disclosed power saving circuit, we find that the standby power consumption is reduced to 3.96 W and the shutdown power consumption is 0 W. Such power consumption is not only much improved from the prior art, and also satisfies the USA EPA standard.

### BRIEF DESCRIPTION OF THE DRAWINGS

The invention will become more fully understood from the detailed description given hereinbelow illustration only, and thus are not limitative of the present invention, wherein:

FIG. 1 is a functional block diagram of the power saving circuit according to an embodiment of the invention;

FIG. 2 is a functional block diagram of the power saving circuit according to another embodiment of the invention;

FIG. 3 is an equivalent circuit diagram of the power control unit according to an embodiment of the invention; and

FIG. 4 is an equivalent circuit diagram of the power control unit according to another embodiment of the invention.

### DETAILED DESCRIPTION OF THE INVENTION

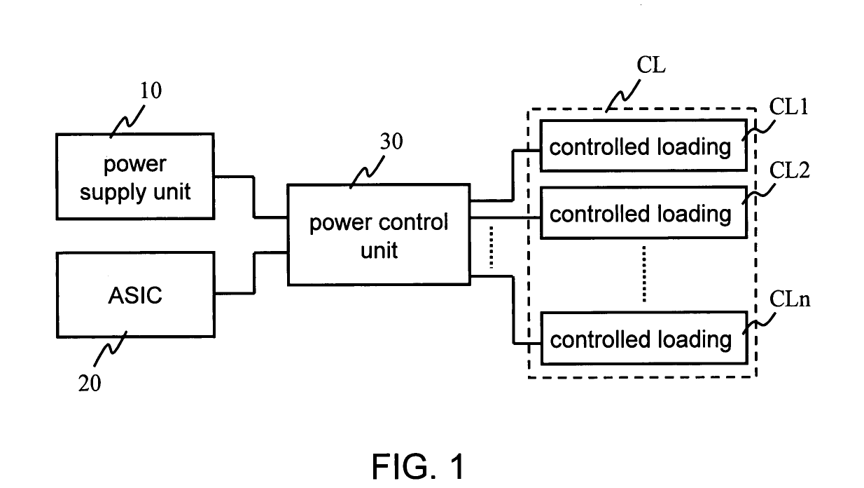

As shown in FIG. 1, this embodiment is a power saving circuit including: an application specific integrated circuit (ASIC) and a power control unit. The power control unit 30 is connected to the ASIC 20 for controlling the power supplied from the power supply unit 10 to the controlled loading CL. The ASIC 20 provides a control signal to the power control unit 30. The power control unit 30 controls the power supplied to the controlled loading CL according to the signal provided by the ASIC 20. The controlled loading CL can include several controlled loadings CL1˜CLn. That is, the power control unit 30 can control the power of several controlled loadings CL1˜CLn. The power control unit 30 can be a power cutting device or a voltage-controlled oscillation device. The power cutting device controls the energy consumption of the controlled loading by cutting or providing its power supply. The voltage-controlled oscillation device controls the energy consumption of the controlled loading by reducing its power supply. The device can be started using a trigger signal, thereby saving the power consumption of the device.

That is, when the device is started, the power control unit 30 mediates the power to the controlled loadings CL (CL1˜CLn). When the device stands by, the power control unit 30 cuts off or reduces the power supply of the controlled loadings CL. Finally, if the device is shut down, the power control unit 30 immediately cuts the power to the controlled loadings CL. The controlled loadings CL are any interior element of the device. In other words, the power of any interior element of the device is controlled by the power control unit 30. Therefore, the invention can achieve the goal of saving energy.

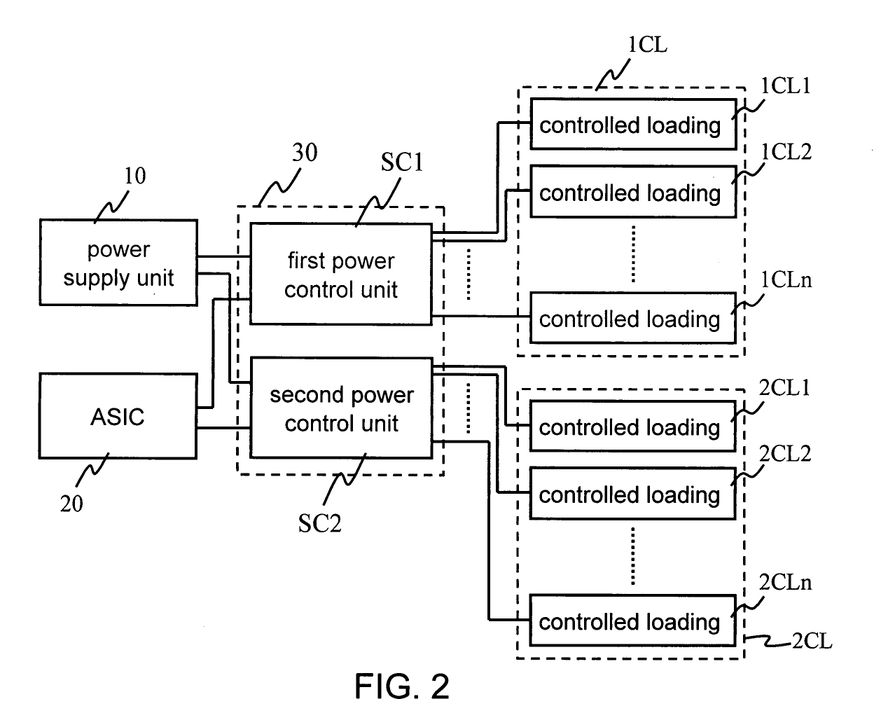

Another embodiment of the invention provides a power saving circuit including: an ASIC, a first power control unit and a second power control unit. With reference to FIG. 2, the power control unit 30 contains the first and second power control units SC1, SC2. The first and second power control units SC1, SC2 are the above-mentioned power cutting device and the voltage-controlled oscillation device, respectively. They are connected to the ASIC 20 to control the power supplied by the power supply unit 10 to the controlled loadings 1CL, 2CL. In other words, the first power control unit SC1 can cut off the power supply to the controlled loading 1CL when the device is not in use. The first power control unit SC1 contains a first signal source, a voltage source, first and second switching units, and a voltage output terminal. The second power control unit SC2 reduces the power supply to the controlled loading 2CL when the device is not in use. A trigger signal can be employed to start the device. The second power control unit SC2 contains second and third signal sources, a voltage source, third and fourth switching units, and a voltage output terminal. The ASIC 20 provides control signals to the first and second power control units SC1, SC2. The first and second power control units SC1, SC2 then control the power supply to the controlled loadings 1CL1, 2CL according to the signals provided by the ASIC 20. Moreover, the controlled loadings 1CL1, 2CL can include several controlled loadings 1CL1˜1CLn and 2CL1˜2CLn, respectively. That is, the first and second power control units SC1, SC2 can simultaneously control several controlled loadings 1CL1˜1CLn and 2CL1˜2CLn, respectively.

When the device is started, the first and second power control units SC1, SC2 provides power to the controlled loadings 1CL (1CL1˜1CLn), 2CL (2CL1˜2CLn). When the device stands by, the first power control unit SC1 first cuts off the power of the controlled loadings 1CL, the second power control unit SC2 then reduces the power supply to the controlled loadings 2CL. Once the device is restarted, the second power control unit SC2 sends off a trigger signal and provides the necessary power to the controlled loadings 2CL. The first power control unit SC1 then provides the necessary power to the controlled loadings 1CL. Finally, the first and second power control units SC1, SC2 immediately cut off the power supplied to the controlled loadings 1CL, 2CL.

In this embodiment, several power control units may be employed to control the power of the controlled loadings according to the number of controlled loadings. That is, more than one power cutting device and/or more than one voltage-controlled oscillation device can be used, according to the practical needs of the electronic device as the power control units.

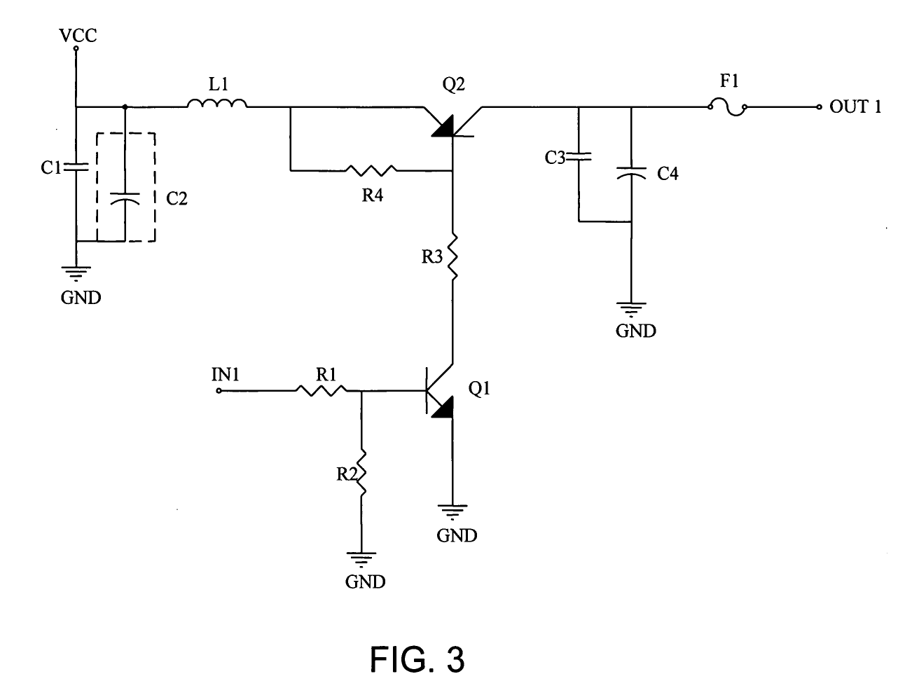

FIG. 3 shows an equivalent circuit diagram of the power control unit in the first embodiment. The power control unit is a power cutting device including a first signal source, a voltage source, first and second switching units, and a voltage output terminal.

The first signal source IN1 is connected to the ASIC to receive the signal generated by the ASIC. The ASIC detects the state of the electronic device and provides voltage signals of different levels accordingly. For a scanner, the ASIC detects whether the scanner is on, standby, restarted or off and provides different levels of voltage signals accordingly. The first and second switching units are first and second transistors Q1, Q2, respectively. The first transistor Q1 is an NPN transistor and the second transistor Q2 is a PNP transistor. The base of the first transistor Q1 is coupled to the first signal source IN1 via an impedance element, which is a first resistor R1. The base of the first transistor Q1 is coupled to the ground line GND via another impedance element, which is a second resistor R2. The emitter of the first transistor Q1 is connected to the ground line GND. The collector of the first transistor Q1 is coupled to the second transistor Q2 via impedance. That is, the collector of the firs transistor Q1 and the base of the second transistor Q2 are connected by a third resistor R3. The base and the emitter of the second transistor Q2 are coupled using impedance, the fourth resistor R4. The collector of the second transistor Q2 is connected to the voltage output terminal OUT1, with a pulse protection device, i.e. a fuse, installed in between.

The voltage source VCC provides a fixed input voltage. A filter can be included for filtering. The voltage source VCC is coupled to the base of the second transistor Q2 via an LC filter. The LC filter is a capacitor input filter and, in particular, an L-type capacitor input filter. That is, the input filter capacitor is directly connected to the voltage source VCC. It has a good filtering effect and can produce a relatively large DC voltage. That is, first and second capacitors C1, C2 are coupled in parallel between the voltage source VCC and the ground line GND. The first inductor L1 is coupled between the voltage source VCC and the base of the second transistor Q2. When the voltage source VCC provides an input voltage, the first and second capacitors C1, C2 filter out ripples in the input voltage. The first inductor L1 then filters out ripples in the input current accompanying the input voltage, rendering a smoother DC input voltage. The second capacitor C2 is coupled in parallel a first capacitor C1 with a smaller capacitance to increase the electric capacity. This is helpful in filtering out high-frequency noises, making the input power pure.

The voltage output terminal OUT1 provides power to the controlled loadings controlled by the first power control unit. For a scanner, the controlled loadings are the interior elements that are not in use during standby. Such elements include the CCD, the stepping motor, the AFE device, the ASIC, and the ADF. Third and fourth capacitors C3, C4 are coupled in parallel between the voltage output terminal OUT1 and the ground line GND to filter out ripples in the output voltage.

In the following, we explain the operation principle of using the power cutting device as the power control unit. When the electronic device is in use, the ASIC provides a high-level voltage signal to the first signal source IN1 of the first power control unit. After the high-level voltage signal enters the first signal source IN1, a bias is generated between the base and the emitter of the first transistor Q1. The base approaches a positive potential so that the first transistor Q1 is conductive and reaches saturation. Thus, the first transistor Q1 is on. At this moment, the voltage on the collector of the first transistor Q1 lowers to a low level (about 0 V), making the voltage on the emitter of the second transistor q2 rise to high. Therefore, a bias is generated between the emitter and the base of the second transistor Q2. The emitter of the second transistor Q2 thus approaches a positive potential, making the second transistor Q2 conductive and reach saturation. Therefore, the second transistor Q2 is on. The voltage output terminal OUT1 provides the output voltage.

When the electronic device is not in use, the ASIC provide a low-level voltage signal to the first signal source IN1 o the first power control unit. After the low-level voltage signal enters the first signal source IN1, the base of the first transistor Q1 approaches a negative potential, and the first transistor Q1 is not conductive. Therefore, the first transistor Q1 is off. At the same time, no bias exists between the emitter and base of the second transistor Q2. Thus, the second transistor Q2 is off, too. The voltage output terminal OUT1 does not provide an output voltage in this case.

For example, when the scanner is turned on or restarted from standby, the ASIC outputs a high-level voltage signal according to the state of the electronic device to the first signal source IN1 of the first power control unit. After the input of the high-level voltage signal, the first and second transistors Q1, Q2 are turned on. Thus, the voltage output terminal OUT1 immediately provides an output voltage to the interior elements (e.g. CCD, stepping motor, AFE device, ASIC, and ADF) controlled by the first power control unit so as to immediately start these interior elements.

When the scanner is turned off or stands by, the ASIC output a low-level voltage signal to the first signal source IN1 of the first power control unit according to the state of the electronic device. After the input of the low-level voltage signal, the first and second transistors Q1, Q2 are turned off, cutting the output voltage on the controlled interior elements (e.g. CCD, stepping motor, AFE device, ASIC, and ADF). That is, the voltage output terminal OUT1 does not provide an output voltage to the controlled interior elements.

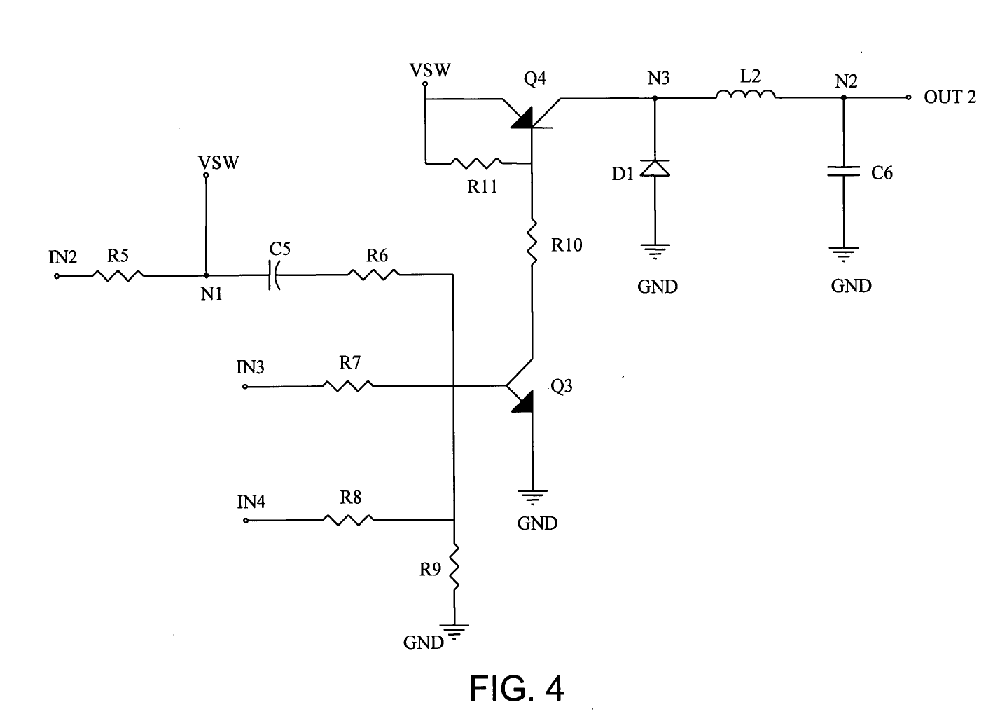

An equivalent circuit diagram of the power control unit in another embodiment of the invention is shown in FIG. 4. Here the power control unit is a voltage-controlled oscillation device, including second and third signal sources, a voltage source, third and fourth switching units, and a voltage output terminal.

As shown in FIG. 4, the second signal source IN2 provides a power supply signal to start the power supply unit. It is coupled to a voltage source VSW via an impedance element, which is a fifth resistor R5. A node N1 is between the voltage source VSW and the fifth resistor R5. The third and fourth signal sources IN3, IN4 are coupled to the ASIC to receive signals generated by the ASIC. The ASIC detects the state of the electronic device, and provides different signals accordingly. For a scanner, the ASIC detects whether it is on, standby, restarted, or off and provides signals accordingly. Here, the third and fourth switching units are the third and four transistors Q3, Q4, respectively. The third transistor Q3 is an NPN transistor, and the fourth transistor Q4 is a PNP transistor. The base of the third transistor Q3 is coupled to one end of four impedance elements, which are the sixth to the ninth resistors R6˜R9. A fifth capacitor C5 is coupled between the sixth resistor R6 and the node N1. The node N1 is further connected to the voltage source VSW, which provides a tunable input voltage. The other ends of the seventh to ninth resistors R7˜R9 are coupled to the third signal source IN3, the fourth signal source IN4, and the ground line GND, respectively. The emitter of the third transistor Q3 is coupled to the ground line GND and its collector is coupled to the fourth transistor Q4 via an impedance element. That is, the collector of the third transistor Q3 and the base of the fourth transistor Q4 are coupled using a tenth resistor R10. The base and the emitter of the fourth transistor Q4 are coupled with impedance, the eleventh resistor R11. The emitter of the fourth transistor Q4 is coupled to the voltage source VSW. The collector of the fourth transistor Q4 is coupled to the voltage output terminal OUT2 via a filter. The filter is an LC filter and, in particular, an inductor input filter. That is, the filter inductor is coupled between the collector of the fourth transistor Q4 and the voltage output terminal OUT2. A node N2 is between the filter inductor and the voltage output terminal OUT2. The node N2 is coupled to the ground line GND via a filter capacitor. The filter inductor and filter capacitor are the second inductor L2 and the sixth capacitor C6, respectively.

Before the voltage output terminal OUT2 provides the output voltage, the second inductor L2 filters out ripples in the input current accompanying the input voltage, rendering a smoother DC input voltage. The sixth capacitor C6 then filters ripples in the output voltage before further output. A protection circuit is provided between the filter and the fourth transistor Q4. That is, a node N3 between the second inductor L2 and the collector of the fourth transistor Q4 is coupled to the ground GND via a diode D1, which is a Schottky diode.

We explain the operation principle of using a voltage-controlled oscillation device as the power control unit. When the electronic device is in use, the ASIC provides a modulation signal of high duty ratio to the fourth signal source IN4 of the power control unit. In this case, the third and fourth transistors Q3, Q4 are turned on or off according to the modulation signal. The voltage source VSW provides an input voltage and the voltage output terminal OUT2 provides an output voltage.

When the electronic device is idle, the ASIC provide a modulation signal of low duty ratio to the fourth signal source IN4 of the power control unit. The third and fourth transistors Q3, Q4 are turned on or off according to the modulation signal, thereby lowering the output voltage of the voltage output terminal OUT2.

When the electronic device is restarted, the ASIC provides a trigger signal to the third signal source IN3 of the power control unit. At this moment, the second signal source IN2 provides a power supply signal according to the trigger signal. A bias is generated between the base and emitter of each of the third and fourth transistors Q3, Q4, making them conductive and saturate. Thus, the third and fourth transistors Q3, Q4 are turned on. The voltage output terminal OUT2 then provides the output voltage. Afterwards, the ASIC provides a modulation signal of high duty ratio to the fourth signal source IN4 of the power control unit for the voltage output terminal OUT2 to keep supplying the output voltage.

Finally, when the electronic device is shut down, the ASIC provides a trigger signal to the third signal source IN3 of the power control unit. The base of the third transistor Q3 approaches a negative potential, shutting down the third transistor Q3. Thus, the third transistor Q3 is off. At the same time, the voltage source VSW does not output an input voltage. No bias exists between the emitter and base of the fourth transistor Q4. The fourth transistor Q4 is thus off, too. The voltage output terminal OUT2 does not provide the output voltage.

For example, when the scanner is in use, the fourth signal source IN4 of the power control unit outputs a modulation signal of high duty ratio. The third and fourth transistors Q3, Q4 turn on and off according to the modulation signal. The voltage source VSW outputs a high-level input voltage. Thus, the voltage output terminal OUT2 immediately provides an output voltage to the interior elements controlled by the second power control unit to immediately start them.

When the scanner is idle, the fourth signal source IN4 of the second power control unit outputs a modulation signal of low duty ratio. The third and fourth transistors Q3, Q4 turn on and off according to the modulation signal. Thus, the voltage output terminal OUT2 outputs a low-level output voltage to the controlled interior elements.

When the scanner is restarted, the third signal source IN3 of the power control unit outputs a trigger signal. The second signal source IN2 provides a power supply signal according to the trigger signal, turning on the third and fourth transistors Q3, Q4. Thus, the voltage output terminal OUT2 provides an output voltage of the original level to the interior elements controlled by the second power control unit. Afterwards, the ASIC provides a high-level voltage signal to the fourth signal source IN4 of the power control unit for the voltage output terminal OUT2 to continue supplying the output voltage, starting the controlled interior elements right away.

When the scanner is turned off, the third signal source IN3 of the power control unit outputs a trigger signal to turn off the third and fourth transistors Q3, Q4. The voltage source VSW does not output any input voltage. Thus, the voltage output terminal OUT2 does not provide an output voltage to the interior elements controlled by the second power control unit, immediately turning of the controlled interior elements.

With simultaneous reference to FIGS. 3 and 4, when using the power cutting device and the voltage-controlled oscillation device as the first and second power control units, respectively, in an electronic device, the inputs of the first and fourth signal sources IN1, IN4 of the power control units come from the signals of the ASIC. The first to the fourth transistors Q1˜Q4 are on and off according to the input signals. Therefore, the voltage output terminals OUT1, OUT2 immediately provide output voltages to the controlled loadings for quick start of the electronic device.

When the electronic device is idle, the inputs of the first and fourth signal sources IN1, IN4 of the power control units come from the signals of the ASIC. The first to the fourth transistors Q1˜Q4 are on and off according to the input signals. In this case, the voltage output OUT1 does not provide any output voltage and the voltage provided by the voltage output OUT2 is lowered. That is, the power of elements controlled by the power cutting device is cut off, and the power of elements controlled by the voltage-controlled oscillation device is reduced.

When the electronic device is restarted, the third signal source IN3 of the second power control unit outputs a trigger voltage. The second signal source IN2 provides a power supply signal according to the trigger signal, turning on the third and fourth transistors Q3, Q4. At the same time, the voltage source VSW provides an input voltage. The voltage output terminal OUT2 immediately provides an output voltage to the interior elements controlled by the second power control unit. The ASIC then provides a signal to the first and fourth signal sources IN1, IN4 of the power control unit for the voltage output terminals OUT1, OUT2 to keep supplying output voltages.

When the electronic device is off, the inputs of the first and third signal sources IN1, IN3 of the power control unit come from the signals of the ASIC, turning off the first to the fourth transistors Q1˜Q4. At the same time, the voltage sources VCC, VSW do not provide any input voltage. Thus, the voltage output terminals OUT1, OUT2 do not provide any output voltage to the interior elements controlled by the power control unit, immediately turning off the controlled loadings.

For example, when the scanner is in use, the inputs of the first to fourth signal sources IN1˜N4 of the power control unit come from the signals of the ASIC. The first to fourth transistors Q1˜Q4 turn on and off according to the input signals. Thus, the voltage output terminals OUT1, OUT2 immediately provide output voltages to the interior elements of the scanner for it to start immediately.

When the scanner is idle, the inputs of the first and fourth signal sources IN1, IN4 of the power control unit come from the signals of the ASIC. The first to fourth transistors Q1˜Q4 turn on and off according to the input signals. In this case, the voltage output OUT1 does not provide any output voltage and the output voltage of the voltage output OUT2 is lowered. That is, the power of most unused elements (e.g. CCD, stepping motor, AFE device, ASIC, and ADF) is turned off and the power of the rest elements (e.g. power supply unit and control unit) is lowered.

When the scanner is restarted, the third signal source IN3 of the second power control unit outputs a trigger voltage. At the same time, the second signal source IN2 provides a power supply signal according to the trigger signal, turning on the third and fourth transistors Q3, Q4. The voltage source VSW provides an input voltage. The voltage output terminal OUT2 immediately provides an output voltage to the interior elements controlled by the second power control unit. Afterwards, the ASIC provides a signal to the first and fourth signal sources IN1, IN4 of the power control unit for the voltage output terminals OUT1, OUT2 to keep supplying output voltages.

When the scanner is turned off, the inputs of the first and third signal sources IN1, IN3 of the power control unit come from the signals of the ASIC, turning off the first to the fourth transistors Q1˜Q4. At the same time, the voltage sources VCC, VSW do not provide any input voltage. Thus, the voltage output terminals OUT1, OUT2 do not provide any output voltage to the interior elements of the scanner, turning off the scanner immediately.

In this case, the scanner applying in which an embodiment of the invention is applied set a trigger switch control the state of the electronic device. When the trigger switch is pressed once the third signal source provides a trigger signal and the second signal source provides a power supply signal according to the trigger signal, and the power output terminal thus provides voltages to the controlled loadings, thereby supplying the power of the electronic device. When the trigger switch is pressed longer than a predetermined period of time the third signal source provides a trigger signal for the third and the fourth switching units to turn off, and the voltage output terminal does not provide any voltage to the controlled loadings, thereby turning down the power of the electronic device. Therefore, the electronic device remains its original state when the trigger switch is pressed shorter than a predetermined period of time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A power saving circuit for saving energy consumption of an electronic device which has at least one controlled loading, comprising:
an application specific integrated circuit (ASIC) for generating at least one signal according to state of the electronic device; and
at least one power control unit connected to the ASIC for providing voltages to the controlled loading.

2. The power saving circuit of claim 1, wherein the power control unit contains:
at least one power cutting devices to selectively cut off voltages which is applied to at least one of the controlled loadings according to the signal from the application specific integrated circuit; and
at least one voltage-controlled oscillation devices for selectively lowering the voltages which is applied to the controlled loadings according to the signal from the application specific integrated circuit.

3. The power saving circuit of claim 2, wherein the power switching device includes:
a first signal source for providing a plurality of signals;
a voltage source for inputting a plurality of voltages;
a first switching unit and a second switching unit whose On/Off states are changed according to the signals from the first signal source; and
a voltage output terminal for providing the voltages from the voltage source to the controlled loadings according to the On/Off states of the first and second switching units.

4. The power saving circuit of claim 3, wherein when the electronic device is in use the first signal source provides a high-level voltage from the ASIC to turn on the first and second switching units, and the voltage output terminal outputs the voltages to the controlled loadings.

5. The power saving circuit of claim 3, wherein when the electronic device is not in use the first signal source provides a low-level voltage signal from the ASIC to turn off the first and second switching units, and the voltage output terminal does not output the voltages to the controlled loadings.

6. The power saving circuit of claim 3, wherein the first and second switching units are transistors.

7. The power saving circuit of claim 3, wherein a filter is installed between the voltage source and the second switching unit.

8. The power saving circuit of claim 3, wherein a pulse protection device is installed between the second switching unit and the voltage output terminal.

9. The power saving circuit of claim 2, wherein the power control unit includes:
a voltage source for inputting a plurality of voltages;
a second signal source for providing a power supply signal;
a third signal source for providing a trigger signal;
a fourth signal source for providing a plurality of modulation signals;
a third switching unit and a fourth switching unit whose On/Off states are changed according to the signal from one of the second and third signal sources; and
a voltage output terminal for providing the input voltages of the voltage source to the controlled loadings according to the On/Off states of the third and fourth switching units.

10. The power saving circuit of claim 9, wherein when the electronic device is in use the fourth signal source provides the modulation signals of high duty ratio from the ASIC for the third and fourth switching units to turn on and off according to the modulation signals and the voltage output terminal supplies the voltages to the controlled loadings.

11. The power saving circuit of claim 9, wherein when the electronic device is idle the fourth signal source provides the modulation signals of low duty ratio from the ASIC for the third and fourth switching units to turn on and off according to the modulation signals, thereby lowering the voltages supplied from the voltage output terminal to the controlled loadings.

12. The power saving circuit of claim 9, wherein when the electronic device is restarted after idle the third signal source provides a trigger signal from the ASIC and the second signal source provides a power supply signal according to the trigger signal to turn on the third and fourth switching units, and the voltage output terminal provide the voltages to the controlled loadings.

13. The power saving circuit of claim 9, wherein when the electronic device is off the third signal source provide a trigger signal from the ASIC and the third and fourth switching units turn off according to the trigger signal, and the voltage output terminal does not output any voltage to the controlled loadings.

14. The power saving circuit of claim 9, wherein the third and fourth switching units are transistors.

15. The power saving circuit of claim 9, wherein a filter is installed between the fourth switching unit and the voltage output terminal.

16. The power saving circuit of claim 9, wherein a protection circuit is installed between the fourth switching unit and the voltage output terminal.

17. The power saving circuit of claim 9, wherein a trigger switch is used to control the state of the electronic device.

18. The power saving circuit of claim 17, wherein when the trigger switch is pressed once the third signal source provides a trigger signal and the second signal source provides a power supply signal according to the trigger signal, and the power output terminal thus provides voltages to the controlled loadings, thereby supplying the power of the electronic device.

19. The power saving circuit of claim 17, wherein when the trigger switch is pressed longer than a predetermined period of time the third signal source provides a trigger signal for the third and the fourth switching units to turn off, and the voltage output terminal does not provide any voltage to the controlled loadings, thereby turning down the power of the electronic device.

20. The power saving circuit of claim 17, wherein the electronic device remains its original state when the trigger switch is pressed shorter than a predetermined period of time.
